(19) United States
(12) Patent Application Publication
(10) Pub. No.: US 2004/0255688 A1
(43) Pub. Date: Dec. 23, 2004

(54) Device for measuring pedal-pushing force for vehicles

(75) Inventors: Choong-Suk Ok, Busan Metropolitan City (KR); Dong-Cheol Lee, Ulsan Metropolitan City (KR); Sung-Wook Han, Busan Metropolitan City (KR); Dong-Hwan Kim, Ulsan Metropolitan City (KR)

Correspondence Address: William R. McClellan, Wolf, Greenfield & Sacks, P.C., 600 Atlantic Avenue, Boston, MA, 02210, US

(73) Assignee: Donghee Industrial Co., Ltd., Ulsan Metropolitan City (KR)

(21) Appl. No.: 10/748,347

(22) Filed: Dec. 30, 2003

(30) Foreign Application Priority Data
Jun. 18, 2003 (KR) 10-2003-0039461

(51) Int. Cl. G01N 3/08

(52) U.S. Cl. 73/818

(57) ABSTRACT

Disclosed herein is a device for measuring a pedal-pushing force applied to a pedal of a vehicle. The device comprises a robot having a robotic arm that moves according to a moving track of the pedal while the posture of the robotic arm is controlled, and a load cell attached to the end of the robotic arm for detecting a pedal-pushing force applied to the pedal. To the end of the load cell is fixed a roller for minimizing frictional force generated at the measured surface of the pedal. The device further comprises a connection bracket fixed to the pedal, a rod having one end fixed to the load cell and the other end inserted into the connection bracket, and a pin for connecting the connection bracket and the rod such that the rod is rotated relative to the connection bracket, whereby a reverse load generated at the pedal is measured. According to the present invention, the pedal-pushing force applied to the pedal is accurately measured, as well as a reverse load generated at the pedal.

### FIELD OF THE INVENTION

The present invention relates to a device for measuring a pedal-pushing force applied to a pedal of a vehicle.

### BACKGROUND OF THE INVENTION

Generally, pedals mounted in a vehicle are classified into an acceleration pedal for accelerating the vehicle, a brake pedal for decelerating and stopping the vehicle, and a clutch pedal for shifting gears of the vehicle. These pedals are pushed by means of the feet of a driver of the vehicle.

The pedal-pushing force is mainly affected by a spring constant of a returning spring or a turnover spring mounted in the pedal. Additionally, the pedal-pushing force may be affected by the weight of a pedal arm or a hysteretic effect due to friction. The pedals must be continuously pushed by means of the feet of the driver while the vehicle is driven. Consequently, the pedal-pushing force may be greatly influenced by fatigue of the feet of the driver.

In this regard, the pedal-pushing force is controlled under strict regulations. The pedal-pushing force varies according to type of the pedal. Specifically, the pedal-pushing force for the acceleration pedal, the pedal-pushing force for the brake pedal, and the pedal-pushing force for the clutch pedal are different from each other. However, it is generally prescribed that the pedal-pushing force has a small load value, for example, not more than 5 kgf. Since the pedal-pushing force has a small load value as mentioned above, it is very important to accurately measure the pedal-pushing force.

FIG. 1 shows a conventional device for measuring a pedal-pushing force applied to a pedal of a vehicle, which is disclosed in Korean Unexamined Patent Publication No. 2001-54639. As shown in FIG. 1, the conventional device for measuring a pedal-pushing force includes a fixing jig 1, which is diagonally fixed to a steering wheel 20 of a vehicle by means of first and second clamping members 2 and 3. To the outer circumference of the fixing jig 1 are attached a displacement gauge 4 for measuring strokes of a pedal 21 by means of cylindrical brackets 6. To one end of the displacement gauge 4 is attached a single-axis load cell 5 for measuring a pedal-pushing force, which is applied to the pedal 21. The displacement gauge 4 and the single-axis load cell 5 are connected to an amplifying unit 9 via lines 7 and 8. The amplifying unit 9 is connected to a controller 10, such as a computer equipped with an analog-digital converter 11 and a display unit 12.

Data measured by means of the displacement gauge 4 and the single-axis load cell 5 are transmitted to the amplifying unit 9 via lines 7 and 8 so that the data are amplified by means of the amplifying unit 9. The data amplified by means of the amplifying unit 9 are transmitted to the analog/digital converter 11 where the amplified data are converted into digital data. The digital data is subjected to various processing routines, such as an analog input data (displacement/pedal-pushing force) processing routine, a storing routine, and an XY cumulative graphing routine using a buffering function, under the control of the controller 10. Subsequently, libraries for measurement and analysis are used so that an imaginary measuring system is created. The results of measurement, i.e., the pedal-pushing force and the stroke of the pedal 21 are outputted on the display unit 12 from the inputted data processed as described above.

The pedal arm is circularly moved about a rotating hinge. The pedal-pushing force is a force applied to the center of the pedal while being perpendicular to the pedal so that the pedal arm is circularly moved. However, the pedal arm is circularly moved according to the stroke of the pedal. As a result, it is very difficult to measure the pedal-pushing force perpendicularly applied to the pedal. This is because a normal vector, which is perpendicular to the pedal, is successively changed according to the stroke of the pedal as the pedal arm is circularly moved. In the conventional device for measuring the pedal-pushing force, the pedal-pushing force is measured on the assumption that the pedal arm is linearly moved, i.e., ignoring the fact that the pedal arm is circularly moved. Consequently, an accurate measurement of the pedal-pushing force is not accomplished by means of the conventional device for measuring the pedal-pushing force.

In the clutch pedal is mounted a turnover spring, which serves to reduce the degree of fatigue of the driver while preventing damage to a response characteristic to the pedal-pushing force applied by means of the driver. FIG. 2a is a graph showing relations between strokes and response forces of a clutch pedal having a turnover spring mounted therein, and FIG. 2b is a view showing a moving track of the pedal. In the clutch pedal having the turnover spring mounted therein, the response force and direction of the turnover spring vary from P1 to P2, from P2 to P3, and from P3 to P4, as shown in FIGS. 2a and 2b, according to the characteristic of the turnover spring and the mechanical characteristic as the pedal is pushed by means of the driver. The direction of the response force is reversed at the position of P2. Specifically, the turnover spring is compressed by means of the pedal-pushing force applied to the pedal at the section between P1 and P2 with the result that resistance to the pedal-pushing force is gradually decreased. The resistance to the pedal-pushing force disappears at the position of P2 with the result that the structural posture of the turnover spring is changed. Consequently, there occurs an operational characteristic in which the pedal is dropped down toward a dash panel so that the direction of the pedal-pushing force of the pedal arm is reversed.

As can be seen from the above description, the measuring part of the conventional device for measuring the pedal-pushing force is separated from the pedal, whereby it is impossible to measure a reverse load. Furthermore, mechanical friction occurs between the pedal and a potentiometer used to measure the stroke of the pedal when the pedal-pushing force is measured, whereby the frictional force due to the mechanical interference is added to the load cell in addition to the response force of the turnover spring. Consequently, the measured value of the pedal-pushing force is inaccurate.

### SUMMARY OF THE INVENTION

The present invention has been made in view of the above problems, and it is an object of the present invention to provide a device for measuring a pedal-pushing force for vehicles that is capable of accurately measuring the pedal-pushing force applied to a pedal.

It is another object of the present invention to provide a device for measuring a pedal-pushing force for vehicles that is capable of accurately measuring a reverse load generated at the pedal.

In accordance with the present invention, the above and other objects can be accomplished by the provision of a device for measuring a pedal-pushing force applied to a pedal of a vehicle, comprising: a robot having a robotic arm that moves according to a moving track of the pedal while the posture of the robotic arm is controlled; and a load cell attached to the end of the robotic arm for detecting a pedal-pushing force applied to the pedal.

Preferably, the device for measuring a pedal-pushing force applied to the pedal according to the present invention further comprises a roller fixed to the end of the load cell for minimizing frictional force generated at the measured surface of the pedal.

Preferably, the device for measuring a pedal-pushing force applied to the pedal according to the present invention further comprises: a connection bracket fixed to the pedal; a rod having one end fixed to the load cell and the other end inserted in the connection bracket; and a pin for connecting the connection bracket and the rod such that the rod is rotated relative to the connection bracket, whereby a reverse load generated at the pedal is measured.

Preferably, the rod is provided at the end thereof having the pin inserted therethrough with a bearing so that the rod can be smoothly rotated about the connection bracket.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a conventional device for measuring a pedal-pushing force applied to a pedal of a vehicle;

FIG. 2a is a graph showing relations between strokes and response forces of a clutch pedal having a turnover spring mounted therein;

FIG. 2b is a view showing a moving track of the pedal;

FIG. 3 is a perspective view showing a device for measuring a pedal-pushing force applied to a pedal of a vehicle according to a preferred embodiment of the present invention;

FIG. 4 is a detailed view showing the end of a robotic arm applied to a pedal having a return spring mounted therein according to the present invention;

FIG. 5 is a detailed view showing the end of a robotic arm applied to a pedal having a turnover spring mounted therein according to the present invention;

FIG. 6 is a sectional view showing the connection of the pedal and the robotic arm by means of a pin shown in FIG. 5; and

FIG. 7 is a view showing the direction of a load cell on the basis of a moving track of the pedal.

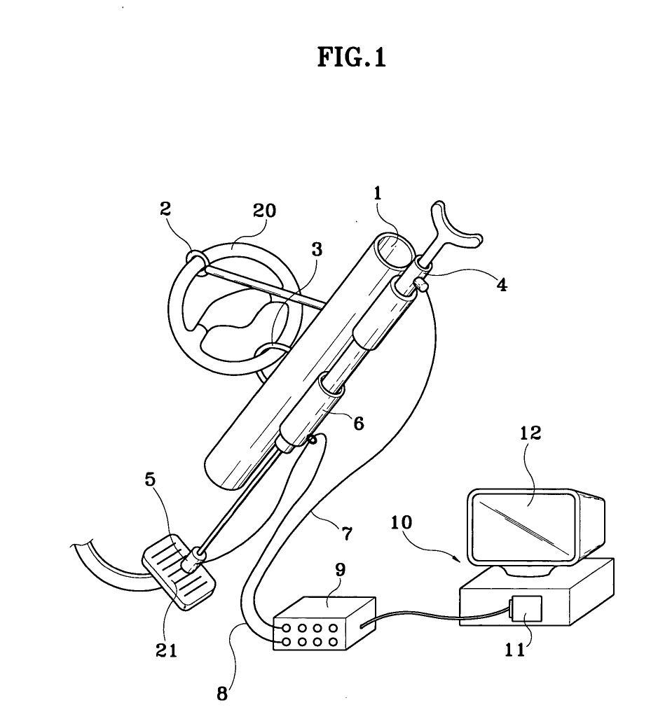

### DESCRIPTION OF THE PREFERRED EMBODIMENTS

The preferred embodiments of the present invention will now be described in detail with reference to the accompanying drawings.

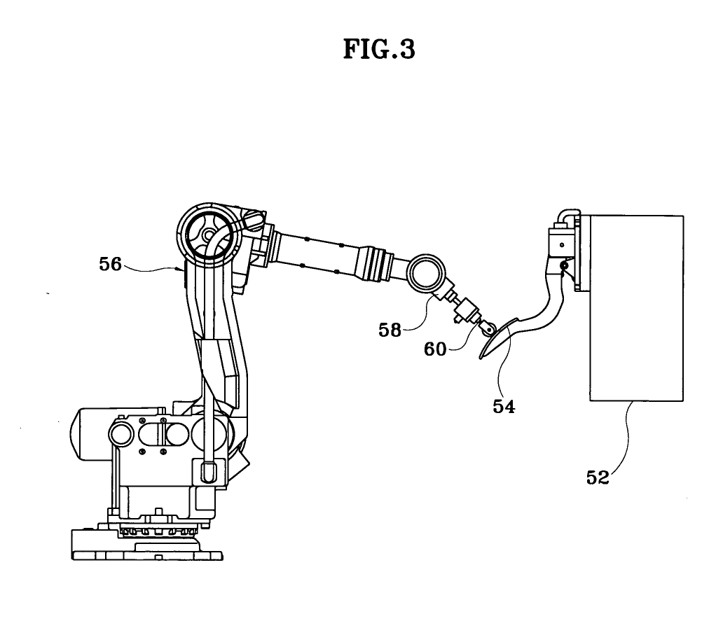

FIG. 3 is a perspective view showing a device for measuring a pedal-pushing force applied to a pedal of a vehicle according to a preferred embodiment of the present invention.

As shown in FIG. 3, the device for measuring a pedal-pushing force applied to the pedal according to the present invention is used to measure a pedal-pushing force applied to a pedal 54, which is fixed to a jig 52 as if the pedal 54 were mounted in a vehicle. The device for measuring a pedal-pushing force according to the present invention comprises: a robot 56 having a robotic arm 58 that moves according to a moving track of the pedal 54 while the posture of the robotic arm 58 is controlled; and a load cell 60 attached to the end of the robotic arm 58 for detecting a pedal-pushing force applied to the pedal 54. As shown in FIG. 3, the end of the robotic arm 58 is applied to the pedal having a return spring mounted therein.

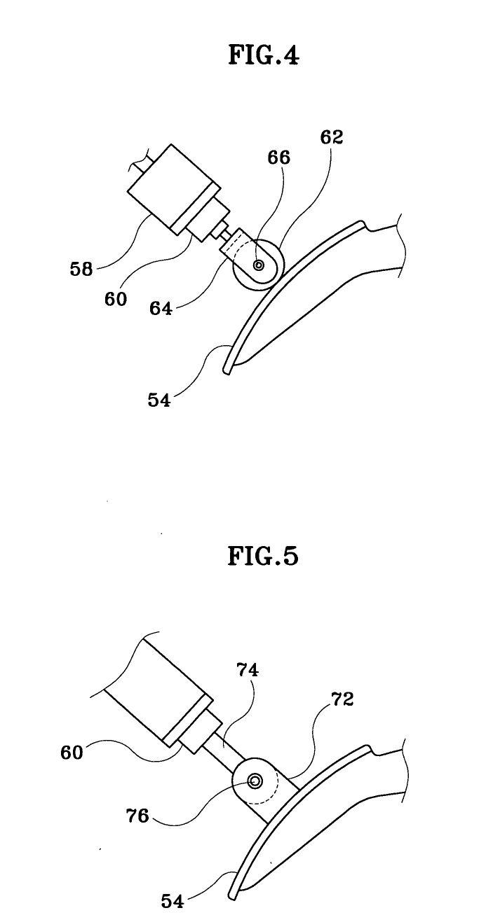

FIG. 4 is a detailed view showing the end of the robotic arm applied to the pedal having the return spring mounted therein. To the end of the load cell 60 is fixed a roller 62, by which frictional force generated at the measured surface of the pedal 54 between the pedal 54 and the end of the robotic arm 58 is minimized.

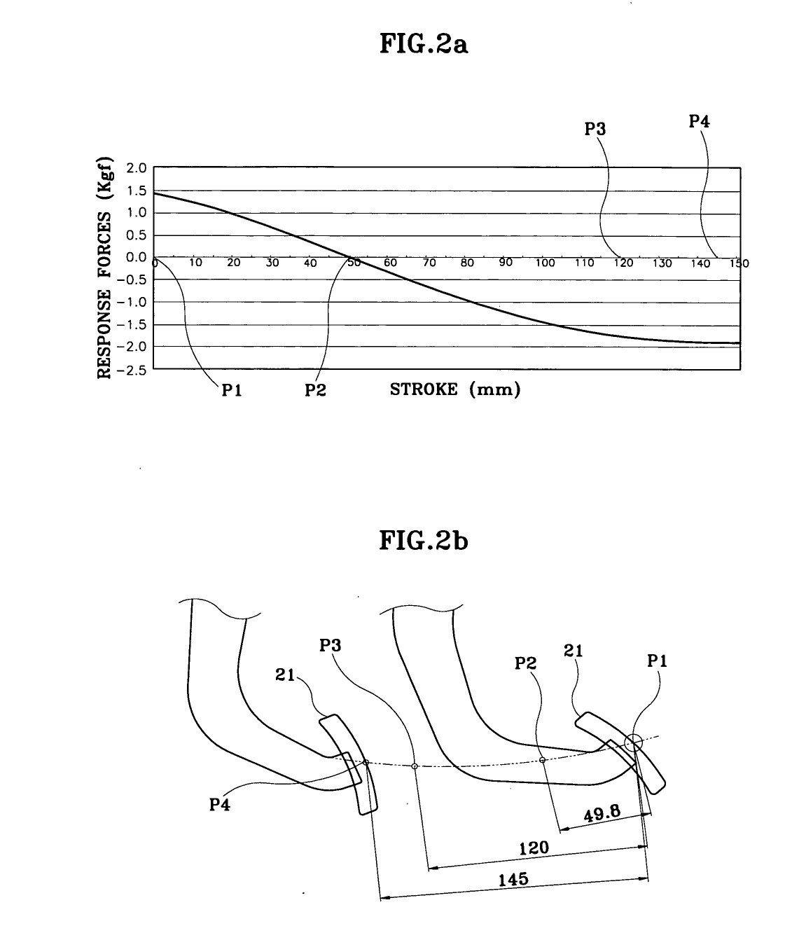

The robot 56 is a vertical multi-jointed robot with 6 degrees of freedom, though other various kinds of robots may be used. The load cell 60 is one of various general load cells that may be used for the conventional device for measuring a pedal-pushing force applied to the pedal. The load cell 60 is attached to the end of the robotic arm 58. The robot 56 moves according to the moving track of the pedal 56 (See FIG. 2) in such a manner that the load cell 60 is always perpendicular to the measured surface of the pedal 54. Consequently, the load is always applied in one direction.

The roller 62 is connected to a bracket 64 fixed to the load cell 60 by means of a pin 66. The bracket 64 is a “[”-shaped bracket having flanges formed at both sides thereof. Between the flanges of the bracket 64 is disposed the roller 62. Preferably, the roller 62 is provided at the inside thereof with a bearing so that the roller 62 can be smoothly rotated about the pin 66.

When the device for measuring a pedal-pushing force applied to the pedal 54 is operated, the posture of the robotic arm 58 of the robot 56 is controlled according to the moving track of the pedal 56 so that a response force of the return spring of the pedal 54 is applied to the measured surface of the pedal 54 while the response force of the return spring of the pedal 54 is perpendicular to the measured surface of the pedal 54. At this time, the roller 62 makes rolling contact with the measured surface of the pedal 54, whereby the frictional force between the pedal 54 and the robotic arm 58 is minimized. Consequently, an accurate measurement of the pedal-pushing force is made possible.

FIG. 5 is a detailed view showing the end of the robotic arm applied to the pedal having a turnover spring mounted therein. To the pedal 54 is fixed a connection bracket 72 as shown in FIG. 5. To the load cell 60 is fixed a rod 74, one end of which is inserted into the connection bracket 72. The rod 74 is connected to the connection bracket 72 by means of a pin 76 in such a manner that the rod 74 is rotated relative to the connection bracket 72. A nut may be fitted at one side of the pin 76 for preventing separation of the pin 76 from the connection bracket 72.

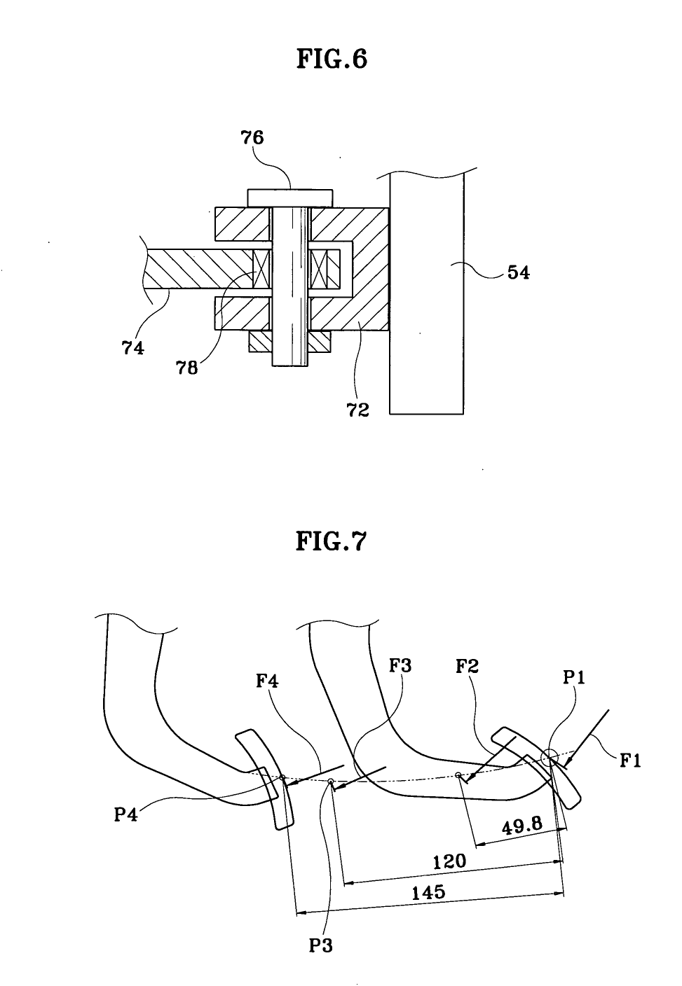

FIG. 6 is a sectional view showing the connection of the pedal 54 and the robotic arm 58 by means of the pin 76 shown in FIG. 5. At the end of the rod 74, through which the pin is inserted, is provided a bearing 78, by which the rod 74 can be smoothly rotated about the connection bracket 72.

The connection bracket 72 is similar to the bracket 64 shown in FIG. 4. The connection bracket 72 is detachably attached to the pedal 54 by means of a fixing unit (not shown). After the measurement of the pedal-pushing force is finished, the connection bracket 72 is separated from the pedal 54.

In the embodiment of the present invention as shown in FIGS. 5 and 6, the rod 74 is not separated from the connection bracket 72 fixed to the pedal 54 during measurement of the pedal-pushing force applied to the pedal 54. Consequently, a reverse load generated at the pedal 54 can also be measured. As the pedal is moved according to its own moving track, i.e., from P1 to P2, from P2 to P3, from P3 to P4, as shown in FIG. 7, the load cell is postured in such a manner that the load cell is always perpendicular to the measured surface of the pedal as indicated by arrows F1, F2, F3, and F4. Consequently, the reverse load can be measured even though the reverse load is applied to the load cell 60 as the pedal passes through the position of P2.

As apparent from the above description, the present invention provides a device for measuring a pedal-pushing force applied to a pedal wherein the direction of the pedal-pushing force is accurately controlled according to a characteristic curve, which varies whenever the stroke of a pedal arm is changed, by means of a robot. Consequently, the present invention has an effect of accurately measuring the pedal-pushing force applied to the measured surface of the pedal while the pedal-pushing force is perpendicular to the measured surface of the pedal. Furthermore, a load due to the structural interference or friction between the pedal and a load cell is minimized, and thus any load excluding the pure pedal-pushing force is eliminated. Consequently, the accuracy of the measurement is improved. Additionally, a reverse load generated at the measured surface of the pedal can also be measured according to the present invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device for measuring a pedal-pushing force applied to a pedal of a vehicle, comprising:
a robot having a robotic arm that moves according to a moving track of said pedal while the posture of said robotic arm is controlled; and
a load cell attached to the end of said robotic arm for detecting a pedal-pushing force applied to said pedal.

2. The device as defined in claim 1, further comprising a roller fixed to the end of said load cell for minimizing frictional force generated at the measured surface of said pedal.

3. The device as defined in claim 1, further comprising:
a connection bracket fixed to said pedal;
a rod having one end fixed to said load cell and the other end inserted into said connection bracket; and
a pin for connecting said connection bracket and said rod such that said rod is rotated relative to said connection bracket, whereby a reverse load generated at said pedal is measured.

4. The device as defined in claim 3, wherein said rod is provided at the end thereof having said pin inserted therethrough with a bearing so that said rod can be smoothly rotated about said connection bracket.
